(19) United States
(12) Patent Application Publication
(10) Pub. No.: US 2008/0226685 A1
(43) Pub. Date: Sep. 18, 2008

(54) Product and Method for Controlling Flying Insects

(75) Inventors: Krishanthi Balakrishnan, New South Wales (AU); Gary Raymond Bowman, New South Wales (AU); Rosita Junus, New South Wales (AU); Bruce Graham Kemmis, New South Wales (AU); Philip Stephen Ridley, New South Wales (AU); Ian Andrew Thompson, New South Wales (AU)

Correspondence Address: MERCHANT & GOULD PC, P.O. BOX 2903, MINNEAPOLIS, MN, 55402-0903, US

(73) Assignee: Reckitt Benckiser (Australia) Pty Limited, West Ryde, NSW (AU)

(21) Appl. No.: 10/578,282

(22) PCT Filed: Nov. 5, 2004
(86) PCT No.: PCT/GB04/04692

§ 371 Date: Nov. 16, 2007

(30) Foreign Application Priority Data
Nov. 7, 2003 (GB) 0326053.6

(51) Int. Cl. A01N 25/34; A01N 37/10; A01P 7/04

(52) U.S. Cl. 424/411; 514/570

(57) ABSTRACT

Insect control articles and methods of controlling insects comprising a cellulosic based substrate or matrix having a specified surface area impregnated and/or dosed with a vapour active pyrethroid in a carrier solvent, such that the vapour active pyrethroid is emanated into the environment at a rate of at least approximately 0.040 mg/h at a temperature of approximately 18-40° C.

### TECHNICAL FIELD

The present invention relates generally to flying insect control and more particularly to a cellulosic based substrate or matrix containing a vapour active pyrethroid that is effective in controlling flying insects, particularly mosquitoes.

### BACKGROUND ART

The control of flying insects in an indoor or an outdoor area has traditionally been achieved using articles or devices that dispense insecticide vapours into the atmosphere. Such articles or devices generally burn or heat a liquid or solid substrate to vaporise the active ingredient. For instance, in controlling mosquitoes, coils impregnated with an active ingredient are burnt so that heat from combustion causes the release of the active ingredient into the atmosphere, citronella oil candles are burnt so as to heat the citronella oil and allow it to evaporate into the atmosphere, while electric devices electrically heat the active ingredient so that it vaporises and is dispersed into the atmosphere. Battery operated, fan driven products are also used to control mosquitoes. The above mentioned products require an energy source in the form of combustion, heat or electricity. The release rates of active insecticides from continuous action products such as mosquito coils, candles, liquid vaporisers and electrically heated mats are essentially independent of the surrounding environment, the driving force for discharge of the active being supplied from within the system.

The abovementioned articles and devices used to control mosquitoes have disadvantages. The combustion of mosquito coils requires a safe burning site and results in ash and smoke. The burning of a candle exposes a naked flame and therefore also requires a safe burning site. The use of electricity to heat an insecticidal device is costly in some developing countries and is not portable.

There also exists ambient temperature moth repellent products that rely on passive evaporation of the insecticide from a substrate into the environment. These products, which have commonly been used to control moths, do not require an external source of energy, such as combustion, heat or electricity to release the insecticide into the atmosphere. Instead, an insecticide that vapourises at ambient temperature is required for these products. The concept of an ambient temperature moth repellent has many benefits: they provide long lasting and continuous protection; they are efficient in that there is no need for a means of heating; and they are portable, modern and practical.

The above known ambient temperature products, however, also have disadvantages. Firstly, many of the prior art products are only effective in small, enclosed spaces and/or require significant air movement for the insecticide to be effective in a larger area of space. Secondly, the inventors are not aware of any cost-effective ambient emanation products that are able to work efficiently using low doses of insecticide for the control of insects other than moths, such as mosquitoes.

There is clearly a need for insecticidal products, particularly cost effective products, that do not require an external input of energy for them to be effective in controlling flying insects, particularly mosquitoes.

Whilst recognising the short comings of prior art articles for controlling mosquitoes and moths, the present inventors have sought to provide an improved vapour active insecticide product with high insecticidal potency in the continuous control of flying insects without the need for electricity, heat or combustion.

### DISCLOSURE OF THE INVENTION

The present inventors have found an effective way of controlling flying insects, in particular mosquitoes, using a combination of substrate, vapour active pyrethroid and carrier solvent that allows emanation of the pyrethroid from the substrate at dose levels that achieve an effective emanation rate and are cost effective.

In a first aspect, the present invention is directed to a cellulosic based substrate or matrix for controlling flying insects, the cellulosic based substrate or matrix impregnated and/or dosed with a vapour active pyrethroid in a carrier solvent, wherein the cellulosic based substrate or matrix has a surface area in the range of 50-5000 cm², and the vapour active pyrethroid is present in an amount of approximately 2.0-3000 mg/m², such that the vapour active pyrethroid is emanated into an environment with non-augmented air movement at a rate of at least approximately 0.040 mg/h at a temperature in the range of approximately 18-40° C.

In a preferred embodiment of the first aspect, the present invention is directed to a cellulosic based substrate or matrix for controlling flying insects, the cellulosic based substrate or matrix impregnated and/or dosed with a vapour active pyrethroid in a carrier solvent, wherein the cellulosic based substrate or matrix has a surface area in the range of 50-5000 cm², the vapour active pyrethroid is selected from the group consisting of metofluthrin, transfluthrin, empenthrin, methothrin, tefluthrin, and fenfluthrin or mixtures thereof and is present in an amount of approximately 2.0-3000 mg/m², and the carrier solvent has an evaporation rate according to ASTM D3539-87 of less than approximately 1.0, a boiling point in the range of approximately 120-330° C. and a Snyder polarity index in the range of approximately 0.0-4.0; such that the vapour active pyrethroid is emanated into an environment with non-augmented air movement at a rate of at least approximately 0.040 mg/h at a temperature in the range of approximately 18-40° C.

In a second aspect, the present invention is directed to a cellulosic based substrate or matrix for controlling flying insects, the cellulosic based substrate or matrix impregnated and/or dosed with an insecticidally effective amount of a vapour active pyrethroid in a carrier solvent, wherein the carrier solvent has an evaporation rate according to ASTM D3539-87 of less than approximately 1.0, a boiling point in the range of approximately 120-330° C. and a Snyder polarity index in the range of approximately 0.0-4.0, such that the vapour active pyrethroid is emanated into the environment at a rate of at least approximately 0.040 mg/h.

In a preferred embodiment of the second aspect, the present invention is directed to a cellulosic based substrate or matrix for controlling flying insects, the cellulosic based substrate or matrix impregnated and/or dosed with an insecticidally effective amount of a vapour active pyrethroid in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a polarity index in the range of approximately 0.0-4.0, such that the vapour active pyrethroid is emanated into the environment at a rate of at least approximately 0.040 mg/h.

In a third aspect, the present invention is directed to flying insect control article comprising:

a) a cellulosic based substrate or matrix with a surface area in the range of 50-5000 cm² impregnated and/or dosed with a solution of vapour active pyrethroid in an amount of approximately 2.0-3000 mg/m² in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a Snyder polarity index in the range of approximately 0.0-4.0;

the cellulosic based substrate or matrix impregnated and/or dosed with the vapour active pyrethroid in an amount such that the vapour active pyrethroid is emanated into an environment with non-augmented air movement at a rate of at least approximately 0.040 mg/h at a temperature in the range of approximately 18-40° C.; and

b) a protective material that is attached to the cellulosic based substrate or matrix into which protective material the vapour active pyrethroid does not migrate and/or is not absorbed;

wherein the cellulosic based substrate and/or matrix exists in a closed and open form such that when in the open form the pyrethroid is able to emanate from the substrate into the environment and when in the closed form the protective material covers the substrate or matrix to minimise emanation of the pyrethroid into the environment.

In a preferred aspect of the third aspect, the present invention is directed to flying insect control article comprising:

a) a cellulosic based substrate or matrix with a surface area in the range of 50-5000 cm² impregnated and/or dosed with a solution of vapour active pyrethroid in an amount of approximately 2.0-3000 mg/m² in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a Snyder polarity index in the range of approximately 0.0-4.0;

the cellulosic based substrate or matrix impregnated and/or dosed with the vapour active pyrethroid in an amount such that the vapour active pyrethroid is emanated into an environment with non-augmented air movement at a rate of at least approximately 0.040 mg/h at a temperature in the range of approximately 18-40° C.; and

b) a protective material that is attached to the cellulosic based substrate or matrix into which protective material the vapour active pyrethroid does not migrate and/or is not absorbed;

wherein the cellulosic based substrate and/or matrix exists in a closed and open form such that when in the open form the pyrethroid is able to emanate from the substrate into the environment and when in the closed form the protective material covers the substrate or matrix to minimise emanation of the pyrethroid into the environment.

In a fourth aspect, the present invention is directed to flying insect control article comprising:

a) a cellulosic based substrate or matrix for controlling flying insects, the cellulosic based substrate or matrix impregnated and/or dosed with an insecticidally effective amount of a vapour active pyrethroid in a carrier solvent, wherein the carrier solvent has an evaporation rate according to ASTM D3539-87 of less than approximately 1.0, a boiling point in the range of approximately 120-330° C. and a polarity index in the range of approximately 0.0-4.0 such that the vapour active pyrethroid is emanated into the environment at a rate of at least approximately 0.040 mg/h; and

b) a protective material that is attached to the cellulosic based substrate or matrix into which protective material the vapour active pyrethroid does not migrate and/or is not absorbed;

wherein the cellulosic based substrate and/or matrix exists in a closed and open form such that when in the open form the pyrethroid is able to emanate from the substrate into the environment and when in the closed form the protective material covers the substrate or matrix to minimise emanation of the pyrethroid into the environment.

In a preferred embodiment of the fourth aspect, the present invention is directed to flying insect control article comprising:

a) a cellulosic based substrate or matrix for controlling flying insects, the cellulosic based substrate or matrix impregnated and/or dosed with an insecticidally effective amount of a vapour active pyrethroid in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a polarity index in the range of approximately 0.0-4.0 such that the vapour active pyrethroid is emanated into the environment at a rate of at least approximately 0.040 mg/h; and

b) a protective material that is attached to the cellulosic based substrate or matrix into which protective material the vapour active pyrethroid does not migrate and/or is not absorbed;

wherein the cellulosic based substrate and/or matrix exists in a closed and open form such that when in the open form the pyrethroid is able to emanate from the substrate into the environment and when in the closed form the protective material covers the substrate or matrix to minimise emanation of the pyrethroid into the environment.

In a fifth aspect, the present invention is directed to a packaged flying insect control article comprising:

a) a cellulosic based substrate or matrix with a surface area in the range of 50-5000 cm² impregnated and/or dosed with a solution of vapour active pyrethroid in an amount of approximately 2.0-3000 mg/m² in a carrier solvent, wherein the cellulosic based substrate or matrix impregnated and/or dosed with the vapour active pyrethroid in an amount such that the vapour active pyrethroid is emanated into a non-augmented environment at a rate of at least approximately 0.040 mg/h at a temperature in the range of approximately 18-40° C.; and

b) a packaging material enclosing the cellulosic based substrate or matrix into which material the vapour active pyrethroid does not migrate and/or is not absorbed;

wherein when the packaging material enclosing the cellulosic based substrate or matrix is removed from around the cellulosic based substrate or matrix, the vapour active pyrethroid is free to emanate from the cellulosic based substrate or matrix exposed to the environment to control flying insects.

In a preferred embodiment of the fifth aspect, the present invention is directed to a packaged flying insect control article comprising:

a) a cellulosic based substrate or matrix with a surface area in the range of 50-5000 cm² impregnated and/or dosed with a solution of vapour active pyrethroid in an amount of approximately 2.0-3000 mg/m² in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a Snyder polarity index in the range of approximately 0.0-4.0;

the cellulosic based substrate or matrix impregnated and/or dosed with the vapour active pyrethroid in an amount such that the vapour active pyrethroid is emanated into a non-augmented environment at a rate of at least approximately 0.040 mg/h at a temperature in the range of approximately 18-40° C.; and

b) a packaging material enclosing the cellulosic based substrate or matrix into which material the vapour active pyrethroid does not migrate and/or is not absorbed;

wherein when the packaging material enclosing the cellulosic based substrate or matrix is removed from around the cellulosic based substrate or matrix, the vapour active pyrethroid is free to emanate from the cellulosic based substrate or matrix exposed to the environment to control flying insects.

In a sixth aspect, the present invention is directed to a packaged flying insect control article comprising:

a) a cellulosic based substrate or matrix for controlling flying insects, the cellulosic based substrate or matrix impregnated and/or dosed with an insecticidally effective amount of a vapour active pyrethroid in a carrier solvent, wherein the carrier solvent has an evaporation rate according to ASTM D3539-87 of less than approximately 1.0, a boiling point in the range of approximately 120-330° C. and a Snyder polarity index in the range of approximately 0.0-4.0 such that the vapour active pyrethroid is emanated into the environment at a rate of at least approximately 0.040 mg/h; and

b) a packaging material enclosing the cellulosic based substrate or matrix into which material the vapour active pyrethroid does not migrate and/or is not absorbed;

wherein when the packaging material enclosing the cellulosic based substrate or matrix is removed from around the cellulosic based substrate or matrix, the vapour active pyrethroid is free to emanate from the cellulosic based substrate or matrix exposed to the environment to control flying insects.

In a preferred embodiment of the sixth aspect, the present invention is directed to a packaged flying insect control article comprising:

a) a cellulosic based substrate or matrix for controlling flying insects, the cellulosic based substrate or matrix impregnated and/or dosed with an insecticidally effective amount of a vapour active pyrethroid in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a polarity index in the range of approximately 0.0-4.0 such that the vapour active pyrethroid is emanated into the environment at a rate of at least approximately 0.040 mg/h; and

b) a packaging material enclosing the cellulosic based substrate or matrix into which material the vapour active pyrethroid does not migrate and/or is not absorbed;

wherein when the packaging material enclosing the cellulosic based substrate or matrix is removed from around the cellulosic based substrate or matrix, the vapour active pyrethroid is free to emanate from the cellulosic based substrate or matrix exposed to the environment to control flying insects.

In a seventh aspect, the present invention is directed to a stable flying insect control article comprising:

a cellulosic based substrate or matrix with a surface area in the range of 50-5000 cm², wet with a solution of vapour active pyrethroid in an amount of approximately 2.0-3000 mg/m² of the surface area and a carrier solvent, enclosed by a packaging material, wherein the vapour active pyrethroid emanates from the cellulosic substrate or matrix into a non-augmented environment at a rate of at least approximately 0.040 mg/h at a temperature in the range of approximately 18-40° C. but does not migrate and/or is not absorbed into the packaging material.

In a preferred embodiment of the seventh aspect, the present invention is directed to a stable flying insect control article comprising:

a cellulosic based substrate or matrix with a surface area in the range of 50-5000 cm², wet with a solution of vapour active pyrethroid in an amount of approximately 2.0-3000 mg/m² of the surface area and a carrier solvent, enclosed by a packaging material;

wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point in the range of approximately 120-330° C. and a Snyder polarity index in the range of approximately 0.0-4.0;

such that the vapour active pyrethroid emanates from the cellulosic substrate or matrix into a non-augmented environment at a rate of at least approximately 0.040 mg/h at a temperature in the range of approximately 18-40° C. but does not migrate and/or is not absorbed into the packaging material.

In an eighth aspect, the present invention is directed to a stable flying insect control article comprising:

a cellulosic based substrate or matrix wet with a solution of an insecticidally effective amount of a vapour active pyrethroid and a carrier solvent having an evaporation rate according to ASTM D3539-87 of less than approximately 1.0, a boiling point in the range of approximately 120-330° C. and a polarity index in the range of approximately 0.0-4.0, enclosed by a packaging material;

wherein the vapour active pyrethroid emanates from the cellulosic substrate or matrix into the environment at a rate of at least approximately 0.040 mg/h but does not migrate and/or is not absorbed into the packaging material.

In a preferred embodiment of the eighth aspect, the present invention is directed to a stable flying insect control article comprising:

a cellulosic based substrate or matrix wet with a solution of an insecticidally effective amount of a vapour active pyrethroid selected from the group consisting of metofluthrin, transfluthrin, empenthrin, methothrin, tefluthrin, and fenfluthrin or mixtures thereof and a carrier solvent having an evaporation rate according to ASTM D3539-87 of less than approximately 1.0, a boiling point in the range of approximately 120-330° C. and a polarity index in the range of approximately 0.0-4.0, enclosed by a packaging material;

wherein the vapour active pyrethroid emanates from the cellulosic substrate or matrix into the environment at a rate of at least approximately 0.040 mg/h but does not migrate and/or is not absorbed into the packaging material.

In a ninth aspect, the present invention is directed to a method for controlling flying insects comprising the steps of:

providing the cellulosic based substrate or matrix or insect control article according to the first to eighth aspects of the invention;

exposing the cellulosic based substrate or matrix to an environment with non-augmented air movement; and

c) allowing the vapour active pyrethroid impregnated within and/or dosed on the cellulosic based substrate or matrix to passively evaporate into the environment.

In a tenth aspect, the present invention is directed to a method of packaging a cellulosic based substrate or matrix or insect control article according to the first to eighth aspects of the invention comprising the steps of:

providing a packaging material through which the vapour active pyrethroid does not migrate and/or is not absorbed;

forming a pouch with the packaging material;

filling the pouch with the cellulosic based substrate or matrix or insect control article; and

d) sealing the pouch.

The cellulosic based substrate or matrix may be any substrate or matrix that contains cellulosic fibres and includes but is not limited to ground wood pulp, chemical wood pulp, straw preferably wheat straw, bagasse (residue from crushed sugarcane), esparto grass, bamboo, flax, hemp, jute and kenafrag fibres (cotton), cotton linters and recycled wastepaper in the form of, for instance, tissue, paper and cardboard. The cellulosic based substrate or matrix may be of varying grade and includes but is not limited to bleached, recycled and virgin cellulosic based substrates or matrices. It will be appreciated that different types of cellulosic based substrates or matrices will affect the emanation rate of the vapour active pyrethroid from the substrate or matrix into the atmosphere. Preferably, the cellulosic based substrate or matrix is paper, more preferably, bleached paper.

It will be understood that a “substrate” is something which underlies or serves as a basis or foundation and a “matrix” is something which gives origin or form to a thing or which serves to enclose it. Accordingly, it will be appreciated that the term “substrate” is more applicable to flat cellulose based articles while the term “matrix” is more applicable to three-dimensional cellulose based articles.

Preferably, the cellulosic based substrate or matrix according to the invention has a grammage in the range of approximately 12 gsm to less than 260 gsm, more preferably in the range of approximately 12 gsm to 150 gsm, even more preferably in the range of approximately 12 gsm to 40 gsm. Most preferably, the cellulosic based substrate or matrix has a grammage of approximately 18 gsm.

According to the present invention, the cellulosic based substrate or matrix is impregnated and/or dosed with a vapour active pyrethroid. The substrate or matrix is deemed “impregnated” with the vapour active pyrethroid when the pyrethroid is either partially or completely distributed within the material of the substrate or matrix in such a manner that the pyrethroid fills all or some of the interstices of the material of the substrate or matrix and is directly held within the substrate or matrix and supported thereby. The substrate is deemed to be “dosed” with the vapour active pyrethroid when a specific quantity of the pyrethroid is applied to the substrate or matrix and absorbed either partially or completely into the pores of the substrate or matrix.

The cellulosic based substrate or matrix according to the invention is impregnated and/or dosed with a vapour active pyrethroid, preferably in an amount of about 2.0-3000 mg/m², more preferably, about 2.0-1000 mg/m². The vapour active pyrethroid is present in an amount that is insecticidally effective upon emanation into the environment. It will be appreciated that the amount of vapour active pyrethroid required per square meter will depend on the period of time the vapour active pyrethroid is required to emanate from the cellulose based substrate or matrix. For instance, for a cellulosic based substrate required to be effective in controlling insects, such as mosquitoes, over a 100 hour period, it is preferred that the cellulosic substrate or matrix be impregnated and/or dosed with vapour active pyrethroid in an amount of approximately 16-320 mg/m², more preferably about 130-320 mg/m². Over a 300 hour period, it is preferred that the cellulosic substrate or matrix be impregnated and/or dosed with vapour active pyrethroid in an amount of approximately 48-960 mg/m², more preferably about 390-960 mg/m². Over a 900 hour period, it is preferred that the cellulosic substrate or matrix be impregnated and/or dosed with vapour active pyrethroid in an amount of approximately 144-2880 mg/m², more preferably, about 1170-2880 mg/m².

Preferably, the cellulosic based substrate or matrix according to the various aspects of the invention has a surface area of about 50-5000 cm², more preferably, 180-2400 cm².

In a preferred embodiment, a surface area of cellulosic based substrate or matrix in the range of approximately 1250-2400 cm² is impregnated with approximately 20-40 mg of vapour active pyrethroid to achieve 100 hours of use, or approximately 60-120 mg of vapour active pyrethroid to achieve 300 hours of use, or approximately 180-360 mg of vapour active pyrethroid to achieve 900 hours of use.

The phrase “surface area” is intended to mean the total geometric or two dimensional surface area of the cellulosic based substrate or matrix that is exposed to the atmosphere or environment into which the vapour active pyrethroid is to emanate. It will be understood that where the cellulosic based substrate or matrix is a flat piece of paper, the surface area is the sum of the area of both sides of the paper. It will further be understood that the surface area of any other configuration will be the sum of the area of the surfaces exposed to the atmosphere/environment. Generally, the inventors have found that an increase in the surface area increases the emanation rate of the vapour active pyrethroid from the cellulosic based substrate or matrix into the atmosphere.

It will be understood that vapour active pyrethroids are those that are volatile at ambient temperature without heat or combustion. The vapour active pyrethroids are preferably selected from the group consisting of metofluthrin (1.4×10−5 mmHg/25° C.), transfluthrin (2.6×10−5 mmHg/25° C., 4.0×10−1 mPa/20° C.), empenthrin (14 mPa/23.6° C.), methothrin, tefluthrin (8.4 mPa/20° C., 50 mPa/40° C.), and fenfluthrin (1 mPa/20° C.). It will be appreciated that one or more vapour active pyrethroids may be employed in the present invention. Preferably, the vapour active pyrethroid is metofluthrin. Metofluthrin has high potency against mosquitoes, flies, and moths. The chemical name of metofluthrin is 2,3,5,6-tetrafluoro-4-(methoxymethyl)benzyl-(EZ)-(1RS,3RS;1RS,3SR)-2,2-dimethyl-3-(prop-1-enyl)cyclopropanecarboxylate. Metofluthrin is available from Sumitomo Chemical Company.

The emanation or release of the vapour active pyrethroid from the cellulosic based substrate or matrix into the atmosphere/environment may be referred to as the emanation rate or release rate and will be understood to mean the depletion of an amount of vapour active pyrethroid from the cellulosic based substrate or matrix over a certain period of time and has a unit of measurement of mg/hour. The emanation rate is a measure of efficacy in controlling flying insects. The inventors have found that the emanation rate is affected by the surface area of the cellulose based substrate or matrix and the amount of the vapour active pyrethroid impregnated and/or dosed onto the substrate or matrix.

The present inventors have found that emanation of a vapour active pyrethroid, preferably metofluthrin, from a cellulosic based substrate or matrix into the atmosphere at a rate of at least approximately 0.040 mg/h, more preferably at least approximately 0.075 mg/h, is required to effectively control flying insects, particularly mosquitoes and moths. The present inventors believe that a lower emanation rate of at least approximately 0.040 mg/h may be more effective in controlling flying insects such as moths, while a higher emanation rate of at least approximately 0.075 mg/h may be more effective in controlling insects such as mosquitoes. Throughout the specification, the emanation rate of approximately 0.040 mg/h may be referred to as the minimum effective emanation rate (MEER). This MEER may be achieved by controlling a variety of parameters including but not limited to the quantity of vapour active insecticide impregnated and/or dosed onto the cellulosic based substrate or matrix; the size, mass and folding of the cellulosic based substrate or matrix; temperature; and air flow.

By virtue of extrapolation, the present inventors expect the emanation rate of vapour active pyrethroid from the cellulosic substrate or matrix of at least approximately 0.040 mg/h, preferably 0.075 mg/h, to be effective in controlling flying insects, particularly mosquitoes, at a temperature in the range of approximately 18-40° C. The possibility of achieving emanation of the vapour active pyrethroid from the cellulosic substrate or matrix according to the present invention at low temperatures in the range of approximately 18-21° C. contributes to the commercially viability of the various aspects of the invention.

Preferably, the vapour active pyrethroid is emanated from the cellulosic matrix or substrate at a rate of at least approximately 0.04 mg/h, preferably at least approximately 0.075 mg/h, at a temperature in the range of about 18-40° C., more preferably about 21-35° C.

It will be understood that an environment with non-augmented air movement refers to natural air movement that passes over and/or through the cellulosic based substrate or matrix, thereby allowing the vapour active insecticide to passively emanate into the atmosphere. It excludes the use of fans, heat and other mechanical means of increasing air movement. Suitable environments include but are not limited to enclosed rooms and open volumes of space, such as patios and the like, with air movement provided by natural air movement.

The cellulosic based substrate/matrix and the insect control devices of the present invention are used to control flying insects. The flying insects may be selected from but not limited to biting Dipterous pests (Order Diptera) such as mosquitoes (Family Culicidea), biting midges (Family Ceratopogonidae), black flies (F. Simulidae), sandflies (certain Psychodidae) and biting flies (various families eg Muscidae and Tabanidae) and non-biting Dipterous insects (e.g. flies and midges of various families including, but not limited to Muscidae, Calliphoridae, Drosophilidae, Chironomidae and Psychodidae) and certain moths (Order Lepidoptera). Preferably, the cellulosic based substrate/matrix and the insect control devices of the present invention are used to control mosquitoes.

It will be understood that “control” of the flying insect population includes but is not limited to any one of or a combination of killing, repelling or knocking down a flying insect. It will be appreciated that a typical way of measuring the performance of an insecticide is in the form of “knockdown”.

Throughout the specification, the term “passive emanation” is used to describe the process by which the vapour active pyrethroid emanates from the cellulosic based substrate or matrix into the atmosphere without the application of external energy.

According to the invention, the cellulosic based substrate or matrix is impregnated and/or dosed with the vapour active pyrethroid, preferably metofluthrin, in a carrier solvent. The carrier solvent may be any solvent or combination of solvents in which the vapour active pyrethroid is soluble.

The inventors have identified three important physical properties of solvents that may be used to characterise and classify preferred carrier solvents. The first is the boiling point, the second is the evaporation rate according to the ASTM D3539-87 and the third is the polarity of the solvent as determined by the Snyder polarity index. (L. R. Snyder, J Chromatographic Science, 1978, 16, 223).

Preferably, the carrier solvent has a boiling point in the range between about 33-330° C., more preferably, about 50-265° C.

The carrier solvent may be selected from, but not limited to, chlorinated hydrocarbons (e.g. 1,1,1-trichloroethane, dichloromethane, chloroform); alcohols (e.g. methanol, ethanol, n-propanol); ketones (e.g. acetone); alcohol and ketone mixtures (e.g. acetone/ethanol (1:1 by volume)); normal paraffins with a boiling point range of about 155-276° C. (e.g. Norpar 12); dearomatised aliphatic hydrocarbons and their blends in the boiling point range of about 33-265° C. (e.g. pentane, heptane, hexane, Exxsol D40, Exxsol D80 and Exxsol DI 00); isoparaffins in the boiling point range of about 150-300° C. (e.g. Isopar G, and Isopar M); glycol ethers in the boiling point range of about 120-243° C.; natural or synthetically derived aroma chemicals, preferably in the boiling point range of approximately 120-250° C. (e.g. monoterpenes and sesquiterpenes, including monoterpene and sesquiterpene alcohols, aldehydes, ketones, esters, oxides and hydrocarbons such as linalool, geraniol, citronellal, citral, geranial, menthone, linalyl acetate, bornyl acetate, 1,8-cineole and limonene); and essential oils.

The inventors have found that the use of low boiling point solvents with high evaporation rates, as defined below by dry dosing, will be effective as carrier solvents. The inventors have also found that the use of higher boiling point solvents with lower evaporation rates, as defined below by wet dosing, leads to a preferred embodiment of the invention. In addition, the inventors of the present invention have surprisingly found that when wet dosing is employed and a solvent with a Snyder polarity index of less than approximately 4.0, preferably less than approximately 0.5, is chosen the release rates for the vapour active pyrethroid from the cellulosic based substrate are increased.

The cellulosic based substrate or matrix is impregnated and/or dosed with the vapour active pyrethroid, preferably metofluthrin, by way of dry or wet dosing.

By wet dosing, it is meant that the vapour active pyrethroid is applied to and carried within the cellulosic based substrate or matrix in the presence of a carrier solvent. The vapour active pyrethroid, preferably metofluthrin, is dissolved in the carrier solvent and the resulting solution is applied to the cellulosic based substrate or matrix such that the vapour active pyrethroid is distributed, preferably evenly, throughout the cellulosic based substrate or matrix. The carrier solvent used in wet dosing is preferably a solvent that doesn't evaporate within approximately 10 minutes application onto the cellulosic based substrate or matrix and more preferably is characterised by having a high boiling point and a low evaporation rate.

Preferably, the carrier solvent for wet dosing has a boiling point in the range of approximately 120-330° C., more preferably approximately 150-265° C., and may be selected from known solvents including but not limited to normal paraffins with a boiling point range of about 155-276° C., such as Norpar 12; dearomatised aliphatic hydrocarbons and their blends in the boiling point range of about 150-265° C. such as Exxsol D40, Exxsol D80 and Exssol D100; isoparaffins in the boiling point range of about 150-300° C. such as Isopar G and Isopar M and glycol ethers in the boiling point range of about 120-243° C.

In a preferred embodiment, the carrier solvent used in wet dosing has an evaporation rate according to ASTM D3539-87 of less than approximately 1.0, a boiling point in the range of approximately 120-330° C., preferably approximately 150-265° C. and a Snyder polarity index in the range of approximately 0.0-4.0, preferably approximately 0.0-0.5.

It has been found that the release rate of the vapour active pyrethroid, preferably metofluthrin, from the cellulosic based substrate or matrix is reduced if the carrier solvent has an extremely high boiling point. For instance, a carrier solvent having a boiling point within the range of about 285-317° C. (eg Exxsol D140) has a lower release rate of vapour active pyrethroid into the atmosphere than carrier solvents having a boiling point within the range of about 150-265° C. (eg Exxsol D40, Exxsol D80, Exxsol DI 00, Isopar G, Isopar M and Norpar 12).

By dry dosing, it is meant that the vapour active pyrethroid is applied to and present on the cellulosic based substrate or matrix in the presence of a volatile carrier solvent. Preferably, the vapour active pyrethroid, preferably metofluthrin, is dissolved in a volatile solvent which distributes the vapour active pyrethroid throughout the cellulose based substrate and then rapidly evaporates into the atmosphere. Preferably, the volatile solvent evenly distributes the vapour active pyrethroid onto the cellulosic substrate or matrix and will effectively evaporate within 10 minutes of application onto the cellulosic based substrate or matrix. More preferably, the carrier solvent is characterised by having a relatively low boiling point and a high evaporation rate. Even more preferably, the volatile solvent has an evaporation rate according to ASTM D3539-87 of greater than 1.0. Preferably, the volatile solvent is selected from known solvents including but not limited to chlorinated hydrocarbons, methanol, ethanol, pentane, hexane, heptane, acetone and mixtures of these solvents such as ethanol/acetone (1:1 by volume).

In a preferred embodiment of the invention in which dry dosing is employed, the vapour active pyrethroid, preferably metofluthrin, is dissolved in the volatile solvent and applied to the substrate, preferably a paper substrate, that will allow the solvent to evaporate at ambient temperature.

It will be understood that solvents used in both wet and dry application of the vapour active pyrethroid to the cellulosic based substrate or matrix may be employed as carrier solvents in all aspects of the present invention that require a carrier solvent.

The term “essential oils” will be understood to mean a volatile and aromatic liquid which is isolated by a physical process from an odoriferous plant of a single botanical species. The oil bears the name of the plant from which it is derived; for example rose oil or lavender oil. These essential oils obtained from plants may be extracted by distillation, steam distillation, expression or by extraction with fats or organic solvents.

It will be understood that “aroma chemicals” are natural isolates or synthetics which have an aroma. The natural isolates are removed mechanically (eg by distillation) or chemically (eg hydrolysis or salt formation) from a natural essential oil. The isolates are further modified. For example rose and lavender oils may be distilled to produce linalool, which may then be acetylated to make linalyl acetate. Aroma chemicals are the main constituents of essential oils. These constituents are generally monoterpenes and sesquiterpenes, including but not limited to alcohols, aldehydes, ketones, esters, oxides and hydrocarbons. Preferably, the natural or synthetically derived aroma chemicals have a boiling point in the range of approximately 120-250° C.

By “stable” insect control article according to the seventh and eighth aspects of the invention, it is meant that the active is stable in the cellulosic based substrate or matrix. More specifically, it will be understood that the insecticidal product will continue to be satisfactory in use after storage for at least 2 years according to the Manual on Development and Use of FAO and WHO Specification for Pesticides (first Edition, 2002). Preferably, the packaged insect control article according to the fifth and sixth aspects of the invention are stable articles.

In the third and fourth aspects of the invention, directed to an flying insect control article, the cellulosic based substrate or matrix is attached to a protective material. In preferred embodiments of the first, second, fifth, sixth, seventh and eighth aspects of the invention, the cellulosic based substrate or matrix may be attached to a protective material. It will be understood that the meaning of the word “attached” includes but is not limited to joined, fastened, connected, annexed or affixed. Accordingly, it will be understood that the cellulosic based substrate or matrix may be attached to the protective material directly or indirectly. In a preferred embodiment of the invention, the cellulosic matrix or substrate has one or two ends that are attached to a backing board that has a protective material on one side. It will be understood that the cellulosic matrix or substrate may be attached directly to the side of the backing board with the protective material, or attached to the side of the backing board that does not have the protective material, thereby being indirectly attached to the protective material. By way of non-limiting example, it will be appreciated that the protective material may be “attached to” the cellulosic substrate or matrix by way of water and solvent based glues, hot-melt adhesives, staples, adhesive tapes and Velcro fasteners.

As discussed below, the cellulosic based substrate or matrix of the invention may be in a closed or open form. When the cellulosic based substrate or matrix is attached to a protective material and is in a closed form, the protective material preferably covers the cellulosic substrate or matrix to minimise emanation of the vapour active pyrethroid into the environment. When the cellulosic based substrate or matrix is enclosed in a packaging material as defined in the fifth, sixth, seventh and eighth aspects of the invention, the cellulosic based substrate or matrix is preferably in a closed form.

It will be appreciated that once the cellulosic based substrate or matrix is impregnated/dosed with the vapour active pyrethroid it may need to be stored for significant periods of time. It is therefore important that the packaging material or protective material is effective in minimising the release/emanation rate of vapour active pyrethroid from the cellulosic based substrate or matrix into the atmosphere. This is most successfully achieved when the packaging material or protective material is a material through which the vapour active pyrethroid will not migrate and/or be absorbed.

Preferably, the packaging/protective material used in the present invention is selected from but not limited to glass; metal foil, preferably aluminium foil, and laminates thereof; polyester, metalised polyester, heat sealable polyester film, polyester based film and formed sheet, such as amorphous PET and crystalline PET, and laminates thereof; and acrylonitrile-methyl acrylate copolymers and laminates thereof.

It has been found that when the cellulosic based substrate or matrix is wet dosed, a greater range of packaging material and protective material can be used than if the cellulosic based substrate or matrix was dry dosed. The present inventors have surprisingly found that wet dosing the cellulosic based substrate or matrix effects the movement of vapour active pyrethroid into the packaging and protective material. In particular, the inventors have found that the movement of vapour active pyrethroid into some material, such as glass; metal foil and laminates thereof; polyester, metalised polyester, heat sealable polyester film, polyester based film and formed sheet, such as amorphous PET and crystalline PET, and laminates thereof; and acrylonitrile-methyl acrylate copolymers and laminates thereof; is reduced if wet dosing rather than dry dosing is employed.

Without being bound by theory, it is thought that in wet dosing, the vapour active pyrethroid has an affinity for the solvent and is less likely to migrate from the cellulose based substrate or matrix. In contrast, it is thought that when dry dosing is employed, the vapour active pyrethroid is absorbed by the substrate or matrix and results in migration of the vapour active pyrethroid into the and through some materials.

Preferably, the packaging/protective material used in the present invention when dry dosing is employed is selected from but not limited to metal foil, glass and crystalline PET. Preferably, the packaging/protective material used in the present invention when wet dosing is employed is selected from but not limited to glass; metal foil and laminates thereof; metalised polyester, heat sealable polyester film, polyester, polyester based film and formed sheet, such as amorphous PET and crystalline PET, and laminates thereof; and acrylonitrile-methyl acrylate copolymers, and laminates thereof. Even more preferably, the packaging/protective material used is laminated metal foil.

As noted above, the emanation rate of the vapour active pyrethroid from the cellulosic based substrate or matrix is affected by a number of parameters including surface area, paper mass and size, the number of folds etc. This in turn means that products effective in killing and/or repelling insects over different time periods, such as for 12 h and 300 h, could be different.

Air movement is required in order for the pyrethroid to emanate from the substrate into the atmosphere. The rate of emanation increases with increased air flow. A minimal air flow, such as the movement of bodies, a small fan in a closed room or open windows and/or doors, is sufficient to allow a minimum emanation rate of approximately 0.040 mg/h, and the preferred emanation rate of approximately 0.075 mg/h.

The cellulosic based substrate or matrix of the invention containing the vapour active pyrethroid may be folded between an open form and a closed form such that they are expandable and re-closable arrangements. This means that when insect control is not required, the cellulosic based substrate or matrix may be closed and stored in a form which minimises the surface area containing the vapour active pyrethroid that is exposed to the atmosphere. Conversely, when insect control is required, the cellulosic based substrate or matrix may be expanded into an open form thereby increasing the surface area of cellulosic based substrate or matrix containing the pyrethroid that is exposed to the atmosphere allowing the pyrethroid to emanate into the atmosphere.

It will be appreciated that various configurations of the cellulosic based substrate or matrix may be adopted. These configurations include but are not limited to Japanese fans, concertina type arrangements and three dimensional structures having a plurality of cells such as honeycomb like arrangements that open and close in a concertina like fashion.

A honeycomb type arrangement may be hung to give a linear configuration, opened on a table to provide a bridge configuration or closed into a circle to give a hanging lantern configuration. It will be appreciated that in forming the circular hanging lantern other configurations prior to the circular form may be adopted. For instance, the honeycomb arrangement may be positioned in an arc of up to 3600. Preferably the cellulosic based substrate or matrix is a honeycomb arrangement made of paper.

In a preferred embodiment of the invention, the cellulosic substrate or matrix is in the form of a paper honeycomb arrangement with two ends. Preferably, the two ends of the honeycomb arrangement are attached to protective material through which the vapour active pyrethroid cannot migrate and/or be absorbed. More preferably, the two ends of the honeycomb arrangement are attached to cardboard laminated with foil, even more preferably, the cellulosic based substrate or matrix forming the honeycomb arrangement and impregnated and/or dosed with the vapour active pyrethroid is attached to the foil side of the cardboard using water based glue.

In a preferred embodiment of the invention, the cellulosic based substrate or matrix is a refill unit for a holding unit that is able to support the cellulosic based substrate or matrix. For instance, the holding unit containing the cellulosic based substrate or matrix may be hung or laid on a table.

The tenth aspect of the invention is directed to a method of packaging cellulosic based substrate or matrix or insect control article according to the invention. It will be appreciated that the forming filling and sealing steps can be carried out according to a number of known procedures.

### BRIEF DESCRIPTION OF DRAWINGS

FIG. 1 is a bar graph showing % knockdown of Aedes aegypti mosquitoes in a 40 m³ test chamber when exposed to various sizes of 18 gsm paper dosed with 150 mg of metofluthrin.

FIG. 2 is a bar graph showing % knockdown of Aedes aegypti mosquitoes knockdown in a 40 m³ test chamber when exposed to various sizes of 18 gsm paper dosed with the same concentration of metofluthrin per square metre (100 mg on A4, 50 mg on A5, 25 mg on A6, 12.5 mg on A7 and 6.25 mg on A8).

FIG. 3 is a bar graph showing the affect of aging at 28° C. of A4 paper dosed with 2 mg of metofluthrin on the % knockdown of Aedes aegypti mosquitoes in a 40 m³ test chamber.

FIG. 4 is a graph showing the combined emanation profile of 14, 20 and 25 mg of metofluthrin from bleached paper (A4, 50 gsm).

FIG. 5 is a graph showing the emanation rate of metofluthrin from a honeycomb configuration at 28° C.

FIG. 6 is a one cell honeycomb configuration with a surface area of 2bc+2bd+4ab

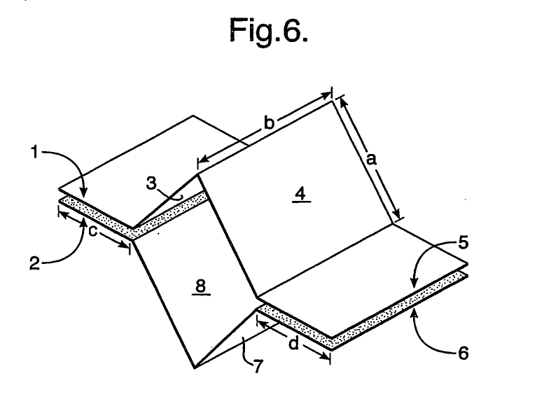

### MODES FOR CARRYING OUT THE INVENTION

In order to understand better the nature of the invention, a number of examples will now be described.

Paper Size and Surface Area:

| | Surface Area | |
|---|---|---|
| A-series paper sizes: | (m²) | |
| A1 - 5000 cm²-0.5 m² | 1 | m² |
| A2 - 2500 cm²-0.25 m² | 0.5 | m² |
| A3 - 1250 cm²-0.125 m² | 0.25 | m² |
| A4 - 625 cm²-0.0625 m² | 0.125 | m² |
| A5 - 312 cm²-0.03125 m² | 0.0625 | m² |
| A6 - 156 cm²-0.01563 m² | 0.03126 | m² |
| A7 - 78.1 cm²-0.00781 m² | 0.01562 | m² |
| A8 - 39.1 cm²-0.00391 m² | 0.00782 | m² |

B) Calculating the Surface Area:

### Example 1

Where the cellulosic based substrate or matrix is a sheet of flat A4 paper:

The surface area of the flat A4 paper is the sum of the area of both sides of the paper and is calculated as follows:

Surface area=area of one side of paper+area of other side of paper

Surface area=625 cm²+625 cm²

Surface area=1250 cm²

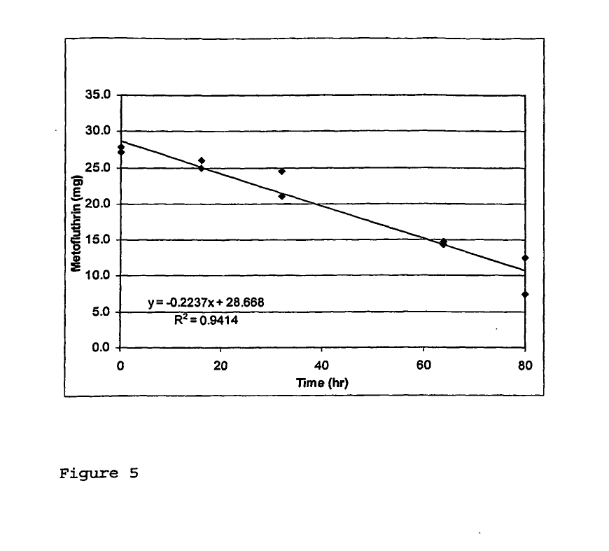

### Example 2

Where the cellulosic based substrate or matrix is a honeycomb configuration according to FIG. 5

FIG. 5 shows one cell of a honeycomb configuration. The surface area of the cell shown in FIG. 5 is the sum of the area of the surfaces exposed to air. There are glue lines between surface 1 and 2 and between surface 5 and 6 which means that each portion of paper forming these surfaces only has one side exposed to air. The portions of paper forming surfaces 3, 4, 7 and 8 all have two sides exposed to air. Accordingly, the surface area for the cell shown in FIG. 5 is calculated as follows:

Surface area (SA)=(SA of surface 1)+(SA of surface 2)+(SA of surface 5)+(SA of surface 6)+(SA of surface 3)×2+(SA of surface 4)×2+(SA of surface 7)×2+(SA of surface 8)×2

Surface area=bc+bc+bd+bd+4(ab)

Surface area=2bc+2bd+4ab

C) Knockdown Studies

The inventors have carried out a number of knockdown studies for the control of mosquitoes using paper surfaces impregnated and/or dosed with the vapour active insecticide metofluthrin. The active was applied to each paper surface as a solution in acetone/ethanol (1:1).

Tests were carried out in a 40 m³ test chamber. The temperature was approximately 28° C. Mixed sex Aedes aegypti mosquitoes were used, aged for 7-10 days after emergence. Up to 200 mosquitoes were introduced into the chamber for each test. Three replicates were done for each treatment. Knocked down mosquitoes were collected at the end of each assessment period and counted.

### Example 3

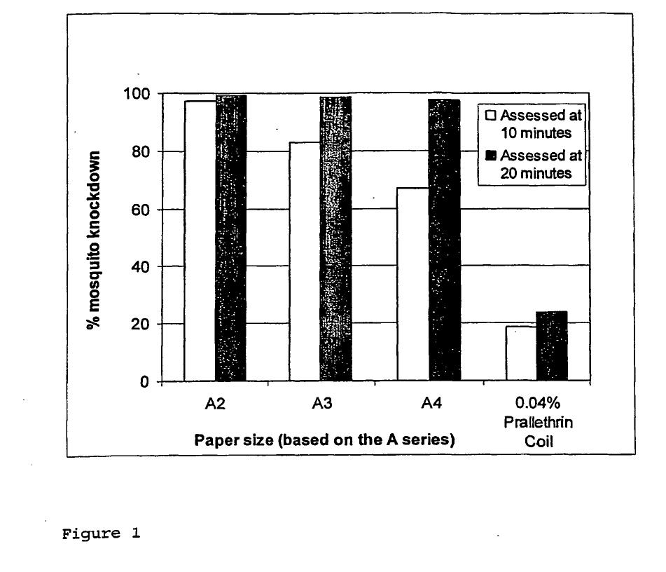

Knockdown studies against the Dengue mosquito Aedes aegypti using three surface areas a) A2, b) A3 and c) A4 of 18 gsm paper in the above test chamber were carried out. Each paper was treated with 150 mg of metofluthrin. A mosquito coil containing 0.04% Prallethrin was included as a reference control. The results are shown in FIG. 1.

The results show that after 10 minutes, an increase in surface area increases product performance. After 20 minutes, all surface areas were equally effective. Further, it shows that all three paper sizes when treated with metofluthrin are more effective than the control.

### Example 4

Knockdown studies were carried out in the above test chamber against the Dengue mosquito Aedes aegypti using five surface areas of 18 gsm paper with five varying doses of metofluthrin a) A4, 100 mg, b) A5, 50 mg, c) A6, 25 mg, d) A7, 12.5 mg, and e) A8, 6.25 mg.

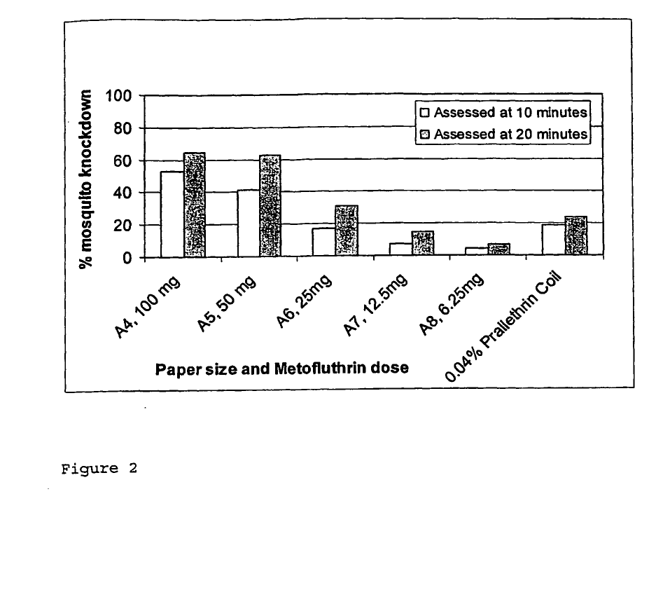

There was a common concentration of 800 mg/m² for all paper samples. A mosquito coil containing 0.04% prallethrin was included as a reference control. The treated paper was hung in the centre of the above chamber. The results are shown in FIG. 2.

The results show that an increase in surface area generally increases product performance. The inventors have concluded that the performance is dependent upon the surface area.

### Example 5

A knockdown study against the Dengue mosquito Aedes aegypti using aged paper was conducted. The test involved treating 18 gsm paper of A4 surface area with 2 mg of metofluthrin at 28° C. for up to 12 hours. The treated paper was hung in the centre of the above chamber. A mosquito coil containing 0.04% prallethrin was included in the trial as a reference control.

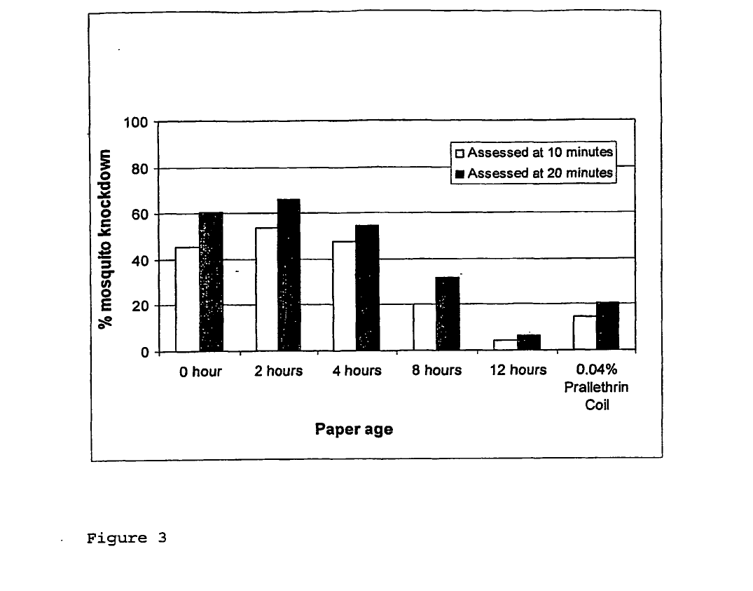

The results are shown in FIG. 3.

The results show that 2 mg of metofluthrin is required on the treated substrate to achieve greater than 40% knockdown for up to 4 hours. At 4 hours, the substrate of the present invention is twice as effective as the control.

D) Studies involving Emanation Rate

### Example 6

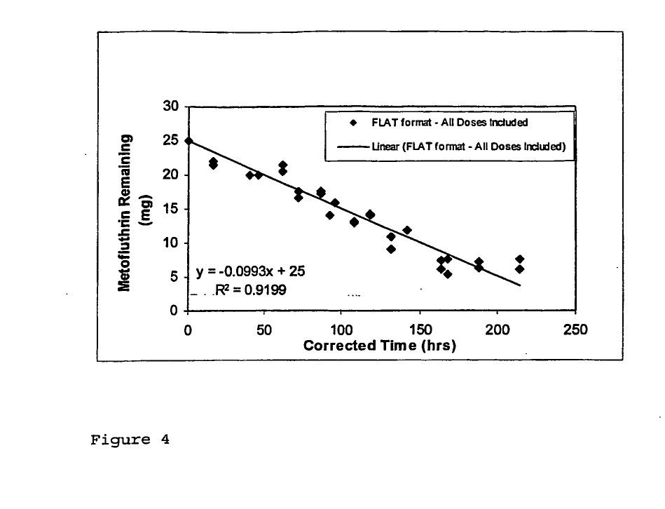

A study involving dosing 50 gsm paper with different amounts of metofluthrin was made to investigate the affect on the emanation rate from this substrate. Three samples of white (A4) paper (50 gsm) each having a surface area of 1250 cm² were dosed with metofluthrin (25, 20 and 14 mg) dissolved in acetone/ethanol (1:1) using the dry dosing technique. The papers were aged in a chamber at 28° C. with low air flow for up to a maximum of 214 hours. The amount of metofluthrin remaining on the paper substrate was measured from time 0 hours to 214 hours. The plot obtained for the emanation rate of metofluthrin from the 25 mg dosed samples was used to estimate the time it would take for 20 and 14 mg of metofluthrin to remain on the samples. A combined plot of the data is shown in FIG. 4.

The inventors have concluded that by varying the initial amount of metofluthrin dosed on to the paper (A4) substrate in the range of 25 mg to approximately 5 mg, the emanation rate is constant. The results also demonstrate that linear release kinetics is observed for metofluthrin emanating from paper substrates. The combined plot enables an average release rate to be determined by fitting a line of best fit to the data so that the average rate of emanation to be determined.

### Example 7

A study involving dosing 18 gsm paper configured into a honeycomb format with an estimated surface area of 2199 cm² with metofluthrin (30 mg) was made to determine the emanation rate from this substrate.

The metofluthrin was dissolved in Norpar 12 and dosed on to the substrate using the wet dosing technique. The papers were hung and aged in a chamber at 28° C. with low airflow for up to a maximum of 80 hours. The amount of metofluthrin remaining on the paper substrate was measured from time 0 hours to 80 hours. The plot obtained for the amount of metofluthrin remaining on samples as a function of time was used to calculate the release rate from this format. A plot of the data is shown in FIG. 5.

The inventors have concluded that an emanation rate of 0.22 mg/hr (at 28° C.) can be achieved from an 18 gsm honeycomb configuration of estimated surface area of 2199 cm². The results also demonstrate that linear release kinetics is observed for metofluthrin emanating from this format.

### Example 8

A study of the metofluthrin emanation rate from 30 gsm paper dosed with different solvents was made.

White (A4) paper (30 gsm) having a surface area of 1250 cm3 was dosed with metofluthrin (14 mg) prepared in a range of solvents, as listed below. The papers were aged in a chamber at 28° C. with low air flow for up to a maximum of 168 hours. The amount of metofluthrin remaining on the paper substrate was measured from time 0 hours to 168 hours. The following solvents were used:

| Solvent | Chemical Description | Supplier/Source |
|---|---|---|
| Exxsol D80 | Dearomatised aliphatic | Exxon Mobil |
| | hydrocarbon | (Australia) |
| Exxsol D40 | Dearomatised aliphatic | Exxon Mobil |
| | hydrocarbon | (Australia) |
| Isopar G | Isoparaffins | Exxon Mobil |
| | | (Australia) |
| HoTung C11-14 | Normal paraffins | Ho Tung (China) |
| Acetone/ethanol (1:1) | Ketone/alcohol mixture | Laboratory reagent |
| Exxsol D140 | Dearomatised aliphatic | Exxon Mobil |
| | hydrocarbon | (Singapore) |

Table 1 summarises the observed emanation rates for each solvent. The inventors have concluded that linear release kinetics are observed for metofluthrin emanating from paper substrates and accordingly, the line of best fit was fitted to obtain the linear equation to enable the rate of emanation to be determined.

TABLE 1

| | | Solvent Specifications | | | |
|---|---|---|---|---|---|
| Solvents | wet/ | Boiling | Evapo- | | Release |
| used | dry | Range | ration | Polarity | Rate |
| for dosing | dosing | (° C.) | Rate* | Index** | Index*** |
| Acetone/ | dry | 56-78 | 2.3-5.7 | 4.3-5.1 | 1.00 |
| ethanol | | | | | |
| Exxsol D80 | wet | 201-245 | 0.02 | ~0.1-0.4 | 1.41 |
| Exxsol D40 | wet | 155-196 | 0.15 | ~0.1-0.4 | 1.40 |
| Isopar G | wet | 155-175 | 0.16-0.28 | ~0.1-0.4 | 1.58 |
| HoTung C11- | wet | 185-221 | 0.04 | ~0.1-0.4 | 1.37 |
| 14 | | | | | |
| Exxsol D140 | wet | 285-317 | <0.01 | ~0.1-0.4 | 0.25 |

*Relative to n-butyl acetate = 1 (ASTM D3539-87)
**According to the Snyder polarity index for solvents (L. R. Snyder, J Chromatographic Science, 1978, 16, 223) (Reference compounds; i-octane = 0.1, n-decane = 0.4, n-hexane = 0.1)
***The release rate index is determined from the observed release rate of metofluthrin from substrates dosed in a solvent relative to the release rate for the samples dosed with metofluthrin in acetone/ethanol (1:1 by volume).

The results indicate that papers dosed with metofluthrin in solvents with boiling ranges from 155-245° C. show an increase in release rate compared to the acetone/ethanol control. Further, extremely high boiling point solvents such as Exxsol D140 cause a drastic reduction in the release rate. In these samples the solvent did not completely evaporate during the study.

In addition, it is observed that solvents with boiling ranges from 155-245° C. and relatively low polarity indexes show an increased release rate compared to the sample dosed with acetone/ethanol (1:1) which has a comparatively high polarity index.

### Example 9

A study of the metofluthrin emanation rate from 18 gsm paper dosed with different solvents was made.

Tissue paper (18 gsm) having an effective surface area of 1250 cm² (A4) was dosed with metofluthrin (14 mg) prepared in a range of solvents. The papers were then aged in a chamber at 28° C. with low airflow for up to a maximum of 168 hours. The amount of metofluthrin remaining on the paper substrate was measured from time 0 hours to 168 hours. The following solvents were used:

| Solvent | Chemical Description | Supplier/Source |
|---|---|---|
| Acetone/ | Ketone/alcohol mixture | Laboratory reagent |
| ethanol (1:1 by | | |
| volume) | | |
| n-pentane | n-pentane | Laboratory reagent |
| Sasol C12-13 | Normal paraffins | Schumann Sasol |
| Isopar L | Isoparaffins | Exxon Mobil (Australia) |
| Dowanol DPM | Glycol ether | Dow Chemicals |
| | | (Australia) |
| Dowanol TPM | Glycol ether | Dow Chemicals |
| | | (Australia) |

Table 2 illustrates the observed emanation rates for each solvent. The inventors have concluded that linear release kinetics are observed for metofluthrin emanating from paper substrates and accordingly, the line of best fit was fitted to obtain the linear equation to enable the rate of emanation to be determined:

TABLE 2

| | | Solvent Specifications | | | |
|---|---|---|---|---|---|
| Solvents | dry/ | Boiling | Evapo- | | Release |
| used | wet | Range | ration | Polarity | Rate |
| for dosing | dosing | (° C.) | Rate * | Index ** | Index *** |
| acetone/ | dry | 56-78 | 2.3-5.7 | 4.3-5.1 | 1.00 |
| ethanol | | | | | |
| n-pentane | dry | 36 | >33 | 0.0 | 1.50 |
| Sasol C12-13 | wet | 188-219 | 0.04 | ~0.1-0.4 | 1.63 |
| Isopar L | wet | 190-207 | ???? | ~0.1-0.4 | 1.75 |
| Dowanol | wet | 190 | 0.035 | >~2 | 1.20 |
| DPM | | | | | |
| Dowanol | wet | 243 | 0.0026 | >~2 | 1.24 |
| TPM | | | | | |

* Relative to n-buryl acetate = 1 (ASTM D3539-87)
** According to the Snyder polarity index for solvents (Reference compounds; i-octane = 0.1, n-decane = 0.4, n-hexane = 0.1, glycols > ~2)
*** The release rate index is determined from the observed release rate of metofluthrin from substrates dosed in a solvent relative to the release rate for the samples dosed with metofluthrin in (acetone/ethanol (1:1)).

The results indicate that papers dosed with metofluthrin in solvents with boiling ranges from 188-243° C. show an increase in release rate compared to the acetone/ethanol control. In addition, it is observed that samples dosed with solvents that have low polarity indexes show significantly increased release rates compared to the sample dosed with acetone/ethanol (1:1) which has a comparatively high polarity index.

The results show that increases in release rate may be a result of a combination of the two parameters, volatility and polarity. The results for n-pentane and the Dowanols indicate that the polarity of the solvent has a stronger influence on release rate than volatility.

### Example 10

The stability and packaging suitability of various materials was studied. In these studies, metofluthrin (14 mg) was applied to A4 sized 30 gsm paper substrates via wet and dry application at ambient temperature. The samples were placed in pouches prepared from the packaging materials under investigation, sealed tightly and stored at 55° C. After periods of one and two weeks, samples were removed from storage and the dosed paper substrates were measured for metofluthrin content. The packaging materials studied were glass, PVC, amorphous PET (APET), crystalline PET (CPET), aluminium foil, heat sealable polyester films, acrylonitrile methyl acrylate copolymer and PEPET. For the wet dosing of metofluthrin on the paper substrate, the metofluthrin was dissolved in Exxsol D80 or Norpar 12 and the resulting solution applied to the substrate. For dry application, the metofluthrin was dissolved in acetone/ethanol (1:1 by volume) and applied to the substrate. The solvent was then allowed to evaporate over a period of 5-10 minutes.

The following table summarises the results obtained:

| | WET DOSING | | DRY DOSING | |
|---|---|---|---|---|
| | Solvent; | | Solvent; | |
| | a = Exxsol D80 | | c = acetone/ethanol | |
| | b = Norpar 12 | | (1:1) | |
| | metofluthrin | | metofluthrin | |
| | recovered from | | recovered from | |
| | paper substrate (%) | | paper substrate (%) | |
| Packaging | 1 week at | 2 weeks at | 1 week at | 2 weeks at |
| Material | 55° C. | 55° C. | 55° C. | 55° C. |
| Glass (bottle) a, c | 100 | 98 | 90 | 81 |
| PVC a, c | 73 | 44 | 64 | 46 |
| APET a, c | 95 | 100 | 87 | 82 |
| CPET a, c | 96 | 100 | 98 | 99 |
| Aluminium foil a, c | 99 | 100 | 99 | 98 |
| heat sealable | — | 100 | — | 92 |
| polyester films a, c | | | | |
| Acrylonitrile | 98 | 99 | — | — |
| methyl acrylate | | | | |
| copolymer b, c | | | | |
| PEPET b, c | 78 | 77 | — | — |

Note 1:
The glass bottle included a PET lid. The lid has been attributed to the loss of metofluthrin observed from the stability experiment when using the dry dosing method.
Note 2:
It should be recognised that an acceptable level of uncertainty for these measurements would be ±5%

The results indicate that packing the product wet limits the movement of the active into the packaging. Further, APET, CPET, glass, heat sealable polyester film, acrylonitrile methyl acrylate copolymer and aluminium foil all appear suitable packaging for wet packaged product. If the product is to be packed dry then CPET and aluminium foil appear to be better packaging options.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A cellulosic substrate for controlling flying insects, comprising the substrate, a vapour active pyrethroid and a carrier solvent, the cellulosic substrate having a surface area comprising 50 to 5000 cm², the vapour active pyrethroid is selected from the group consisting of metofluthrin, transfluthrin, empenthrin, methothrin, tefluthrin, and fenfluthrin or mixtures thereof, the vapour active pyrethroid is present in an amount of approximately 2.0-3000 mg-m² the carrier solvent has an evaporation rate according to ASTM D3539-87 of less than approximately 1.0, a boiling point range at or above about 120° C. to below about 3.0° C. and a Snyder polarity index in the range of approximately 0.0-4.0; the substrate configured such that the vapour active pyrethroid is released into an environment with non-augmented air movement at a rate of at least approximately 0.04 mg-h⁻¹ at a temperature in the range of approximately 1840° C.

2. The cellulosic substrate of claim 1, wherein the solvent is selected from the group consisting of normal paraffins with a boiling point range of about 155-276° C., dearomatised aliphatic hydrocarbons and their blends in the boiling point range of about 150-265° C., isoparaffins in the boiling point range of about 150-300° C. and glycol ether in the boiling point range of about 120-243° C.

3. The cellulosic substrate of claim 1 wherein the carrier solvent has a boiling point in the range of approximately 150-265° C.

4. A cellulosic substrate for controlling flying insects, the cellulosic substrate comprising an insecticidally effective amount of a vapour active pyrethroid and a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point range at or above about 120° C. to blow about 300° C. and a polarity index in the range of approximately 0.0-4.0, such that the vapour active pyrethroid is released into the environment at a rate of at least approximately 0.040 mg-h⁻¹.

5. The cellulosic substrate of claim 4, wherein the vapour active pyrethroid is metofluthrin.

6. The cellulosic substrate of claim 1 wherein the cellulosic substrate comprises a vapour active pyrethroid in an amount of approximately 16-320 mg-m² of the substrate surface area.

7. The cellulosic substrate of claim 6 wherein the vapour active pyrethroid is in an amount of approximately 130-320 mg-m⁻².

8. The cellulosic substrate of claim 1 wherein the cellulosic substrate comprises a vapour active pyrethroid in an amount of approximately 48-960 mg-m⁻² of the substrate surface area.

9. The cellulosic substrate of clam 8 wherein the vapour active pyrethroid is in an amount of approximately 390-960 mg-m⁻².

10. The cellulosic substrate of claim 1 wherein the cellulosic substrate comprises a vapour active pyrethroid in an amount of approximately 144-2880 mg-m⁻² of the substrate surface area.

11. The cellulosic substrate of claim 10 wherein the vapour active pyrethroid is in an amount of approximately 1170-2880 mg-m⁻².

12. The cellulosic substrate of claim 1 wherein the vapour active pyrethroid is released into the environment at a temperature in the range of approximately 21-40° C.

13. The cellulosic substrate of claim 1 wherein the vapour active pyrethroid is released into the environment at a rate of at least approximately 0.075 mg-h⁻¹.

14. The cellulosic substrate claim 1 wherein the vapour active pyrethroid is released into the environment at a rate of at least approximately 0.075 mg-h⁻¹ at a temperature in the range of approximately 21-35° C.

15. The cellulosic substrate of claim 1 wherein the cellulosic substrate comprises about 12 to less than 260 m⁻².

16. The cellulosic substrate of claim 15, wherein the cellulosic substrate comprises about 18 to 40 m⁻².

17. The cellulosic substrate claim 1 wherein the cellulosic substrate is a paper substrate comprising 18 m⁻².

18. The cellulosic substrate of claim 1, wherein the cellulosic substrate comprises a honeycomb.

19. The cellulosic substrate of claim 18, wherein the honeycomb comprises two ends, each end attached to a protective material into which the vapour active pyrethroid cannot migrate.

20. The cellulosic substrate of claim 19, wherein the honeycomb has an open form that allows release of the vapour active pyrethroid into the atmosphere and a closed form which inhibits release of the vapour active pyrethroid into the atmosphere.

21. The cellulosic substrate of claim 1 wherein the flying insects are controlled by knockdown.

22. The cellulosic substrate of claim 1 wherein the flying insects are mosquitoes.

23. A flying insect control article comprising:
a) a cellulosic substrate comprising a surface area in the range of 50-5000 cm² comprising a solution of vapour active pyrethroid in an amount of approximately 2.0-3000 mg-m⁻² in a carrier solvent, wherein the vapour active pyrethroid is selected from the group consisting of metofluthrin, transfluthrin, empenthrin, methothrin, tefluthrin, and fenfluthrin or mixtures thereof; and the carrier solvent has an evaporation rate according to ASTM D3539-87 of less than approximately 1.0, a boiling point range at or above about 120° C. to below about 300° C. and a Snyder polarity index in the range of approximately 0.0-4.0; the cellulosic substrate comprising the vapour active pyrethroid in an amount such that the vapour active pyrethroid is released into an environment with non-augmented air movement at a rate of at least approximately 0-040 mg-m⁻¹ at a temperature in the range of approximately 18-40° C.; and
b) a protective material that is attached to the cellulosic substrate into which protective material the vapour active pyrethroid does not migrate; wherein the cellulosic substrate comprises a closed form and open form such that the open form the pyrethroid is effectively released from the substrate into the environment and in the closed form the protective material covers the substrate to minimise release of the pyrethroid into the environment.

24. The insect control article according to claim 23 wherein the solvent is selected from the group consisting of normal paraffins with a boiling point range of about 155-276° C., dearomatised aliphatic hydrocarbons and their blends in the boiling point range of about 150-265° C., isoparaffins in the boiling point range of about 150-300° C. and glycol ethers in the boiling point range of about 120-243° C.

25. The insect control article of claim 23 wherein the carrier solvent has a boiling point in the range of approximately 150-265° C.

26. A flying insect control article comprising:
a) a cellulosic substrate for controlling flying insects, the cellulosic substrate comprising an insecticidally effective amount of a vapour active pyrethroid and a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point range at or above about 120° C. to below about 300° C. and a polarity index in the range of approximately 0.0-4.0 such that the vapour active pyrethroid is released into the environment at a rate of at least approximately 0.040 mg-h⁻¹; and
b) a protective material that is attached to the cellulosic substrate into which protective material the vapour active pyrethroid does not migrate;
wherein the cellulosic substrate comprises a closed form and open form such that in the open form the pyrethroid is released from the substrate and when in the closed form the protective material covers the substrate to minimise release of the pyrethroid into the environment.

27. The insect control article of claim 26, wherein the vapour active pyrethroid is metofluthrin

28. The insect control article of claim 26 wherein the cellulosic substrate comprise a honeycomb.

29. The insect control article of claim 28, wherein the honeycomb arrangement has two ends and each end is attached to the protective material.

30. A packaged flying insect control article comprising:
a) a cellulosic substrate having a surface area in the range of 50-5000 cm² comprising about 2.0-3000 mg-m² of vapour active pyrethroid and a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point range at or above about 120° C. to below about 300° C. and a Snyder polarity index in the range of approximately 0.0-4.0; the cellulosic substrate comprising the vapour active pyrethroid in an amount such that the vapour active pyrethroid is released into a non-augmented environment at a rate of at least approximately 0.040 mg-h⁻¹ at a temperature in the range of approximately 18-40° C.; and
b) a packaging material enclosing the cellulosic substrate into which material the vapour active pyrethroid does not migrate; wherein when the packaging material enclosing the cellulosic substrate is removed from around the cellulosic substrate, the vapour active pyrethroid is released to control flying insects.

31. The insect control device of claim 30 wherein the solvent is selected from the group consisting of normal paraffins with a boiling point range of about 155-276° C., dearomatised aliphatic hydrocarbons and their blends in the boiling point range of about 150-265° C., isoparaffins in the boiling point range of about 150-300° C. and glycol ethers in the boiling point range of about 120-243° C.

32. The packaged flying insect control article of claim 30 wherein the carrier solvent has an evaporation rate according to ASTM D3539-87 of less than approximately 1.0, a boiling point in the range of approximately 150-265° C.

33. A packaged flying insect control article comprising:
a) a cellulosic substrate comprising an insecticidally effective amount of a vapour active pyrethroid in a carrier solvent, wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point range at or above about 120° C. to below about 300° C. and a polarity index in the range of approximately 0.0-4.0 such that the vapour active pyrethroid is released into the environment at a rate of at least approximately 0.040 mg-h⁻¹; and
b) a packaging material enclosing the cellulosic substrate into which material the vapour active pyrethroid does not migrate; wherein when the packaging material enclosing the cellulosic substrate is removed from around the cellulosic substrate, the vapour active pyrethroid is released to control flying insects.

34. The insect control device of claim 33, wherein the vapour active pyrethroid is metofluthrin.

35. A stable flying insect control article comprising: a cellulosic substrate with a surface area in the range of 50-5000 cm², comprising about 2.0-3000 mg-m⁻² of vapour active pyrethroid in a carrier solvent, enclosed by a packaging material; wherein the vapour active pyrethroid is selected from the group consisting of metofluthrin, transfluthrin, empenthrin, methothrin, tefluthrin, and fenfluthrin or mixtures thereof and the carrier solvent has an evaporation rate according to ASTM D3539-87 of less than approximately 1.0, a boiling point range at or above about 120° C. to below about 300° C. and a Snyder polarity index in the range of approximately 0.0-4.0; such that the vapour active pyrethroid is released from the cellulosic substrate into a non-augmented environment at a rate of at least approximately 0.040 mg-h⁻¹ at a temperature in the range of approximately 18-40° C. but does not migrate into the packaging material.

36. The insect control article of claim 35 wherein the solvent is selected from the group consisting of normal paraffins with a boiling point range of about 155-276° C., dearomatised aliphatic hydrocarbons and their blends in the boiling point range of about 150-265° C., isoparaffins in the boiling point range of about 150-300° C. and glycol ethers in the boiling point range of about 120-243° C.

37. The stable flying insect control article of claim 35 wherein the carrier solvent has a boiling point in the range of approximately 150-265° C.

38. A stable flying insect control article comprising: a cellulosic substrate comprising a solution of an insecticidally effective amount of a vapour active pyrethroid selected from the group consisting of metofluthrin, transfluthrin, empenthrin, methothrin, tefluthrin, and fenfluthrin or mixtures thereof and a carrier solvent having an evaporation rate according to ASTM D3539-87 of less than approximately 1.0, a boiling point range at or above about 120° C. to below about 300° C. and a polarity index in the range of approximately 0.0-4.0, enclosed by a packaging material; wherein the vapour active pyrethroid released from the cellulosic substrate into the environment at a rate of at least approximately 0.040 mg-h⁻¹ but does not migrate into the packaging material.

39. The insect control article of claim 38, wherein the vapour active pyrethroid is metofluthrin.

40. The insect control article of claim 39 wherein the vapour active pyrethroid is released into the atmosphere at a rate of at least approximately 0.075 mg-h⁻¹ at a temperature in the range of about 21-35° C.

41. The insect control article claim 40 wherein the cellulosic substrate comprises about 12 to less than 260 g-m².

42. The insect control article claim 41 wherein the cellulosic substrate is a paper substrate comprising about 18 g-m².

43. The packaged insect control device claim 39, wherein the cellulosic substrate comprises a paper honeycomb.

44. The insect control device of claim 43, wherein the honeycomb has two ends each end attached to material through which the vapour active pyrethroid cannot migrate.

45. The insect control device of claim 44, wherein the honeycomb comprises an open born that releases the vapour active pyrethroid into the atmosphere and a closed form which inhibits release of the vapour active pyrethroid into the atmosphere.

46. The insect control article claim 45, wherein the protective material and packaging material is selected from the group including metalised polyester, heat sealed polyester films, polyester film and formed sheet and acrylonitrile-methyl acrylate copolymers and laminates thereof.

47. The insect control article claim 45, wherein the protective material and packaging material comprises a metal foil a laminate thereof.

48. The insect control article claim 45, wherein the protective material and packaging material is glass.

49. A flying insect control article comprising:
a) a cellulosic substrate with a surface area in the range of 50-5000 cm² comprising a solution of 2.0-3000 mg-m⁻² vapour active pyrethroid in a carrier solvent, the cellulosic substrate comprising the vapour active pyrethroid in an amount such that the vapour active pyrethroid is released into an environment with non-augmented air movement at a rate of at least approximately 0.040 mg-h⁻¹ at a temperature in the range of approximately 18-40° C.; and
b) a protective material that is attached to the cellulosic substrate into which protective material the vapour active pyrethroid does not migrate; wherein the protective material and packaging material is selected from the group including metalised polyester, heat sealed polyester films, polyester film and formed sheet and acrylonitrile-methyl acrylate copolymers and a laminate thereof; metal foil and a laminate thereof; and glass; and
the cellulosic substrate comprises a closed form and an open form such that when in the open form the pyrethroid is released from the substrate and when in the closed form the protective material covers the substrate to minimize release of the pyrethroid.

50. A flying insect control article comprising:
a) a cellulosic substrate for controlling flying insects, the cellulosic substrate comprising an insecticidally effective amount of a vapour active pyrethroid and a carrier solvent, wherein the carrier solvent has an evaporation rate according to ASTM D3539-87 of less than approximately 1.0, a boiling point range at or above about 120° C. to below about 300° C. and a polarity index in the range of approximately 0.0-4.0 such that the vapour active pyrethroid is released into the environment at a rate of at least approximately 0.040 mg-h⁻¹; and
b) a protective material that is attached to the cellulosic substrate into which protective material the vapour active pyrethroid does not migrate; wherein the protective material and packaging material is selected from the group including metalised polyester, heat sealed polyester films, polyester film and formed sheet and acrylonitrile-methyl acrylate copolymers and laminates thereof; metal foil and laminates thereof; and glass; and
the cellulosic substrate comprises a closed form and an open form such that when in the open form the pyrethroid is released and when in the closed form the protective material covers the substrate to minimize release.

51. A packaged flying insect control article comprising:
a) a cellulosic substrate with a surface area in the range of 505000 cm² comprising a solution of about 2.0-3000 mg-m⁻² of a vapour active pyrethroid in a carrier solvent, the cellulosic substrate comprising vapour active pyrethroid in an amount such that the vapour active pyrethroid is released into a non-augmented environment at a rate of at least approximately 0.040 mg-h⁻¹ at a temperature in the range of approximately 18-40° C.; and
b) a packaging material enclosing the cellulosic substrate into which material the vapour active pyrethroid does not migrate;
wherein the protective material and packaging material is selected from the group including metalised polyester, heat sealed polyester films, polyester film and formed sheet and acrylonitrile-methyl acrylate copolymers and laminates thereof; metal foil and laminates thereof; and glass; such that when the packaging material enclosing the cellulosic substrate is removed from around the cellulosic substrate, the vapour active pyrethroid is released to control flying insects.

52. A packaged flying insect control article comprising:
a) a cellulosic substrate for controlling flying insects, the cellulosic substrate comprising an insecticidally effective amount of a vapour active pyrethroid in a carrier solvent, such that the vapour active pyrethroid is released into the environment at a rate of at least approximately 0.040 mg-h⁻¹; and
b) a packaging material enclosing the cellulosic substrate into which material the vapour active pyrethroid does not migrate; wherein the protective material and packaging material is selected from the group including metalised polyester, heat sealed polyester film, polyester film and formed sheet and acrylonitrile-methyl acrylate copolymers and laminates thereof; metal foil and laminates thereof; and glass; and after removal of the packaging material from around the cellulosic substrate, the vapour active pyrethroid is released to control flying insects.

53. A stable flying insect control article comprising:
a cellulosic substrate with a surface area comprising about 50-5000 cm², comprising 2.0-3000 mg-m⁻² of a vapour active pyrethroid and a carrier solvent, enclosed by a packaging material;
wherein the protective packaging material is selected from the group including metalised polyester, heat sealed polyester films, polyester based-film and formed sheet and acrylonitrile-methyl acrylate copolymers and a laminate thereof; metal foil and a laminate thereof; and glass; and
such that the vapour active pyrethroid emanates from the cellulosic substrate into a non-augmented environment at a rate of at least approximately 0.040 mg-h⁻¹ at a temperature in the range of approximately 18-40° C. but does not migrate into the packaging material.

54. A stable flying insect control article comprising:
a cellulosic substrate comprising a solution of an insecticidally effective amount of a vapour active pyrethroid and a carrier solvent having an evaporation rate according to ASTM D3539-87 of less than approximately 1.0, a boiling point range at or above about 120° C. to below about 300° C. and a polarity index in the range of approximately 0.0-4.0, enclosed by a packaging material; wherein the protective packaging material is selected from the group including metalised polyester, heat sealed polyester films, polyester film and formed sheet and acrylonitrile-methyl acrylate copolymers and a laminate thereof; metal foil and a laminate thereof; and glass; and the vapour active pyrethroid is released from the cellulosic substrate into the environment at a rate of at least approximately 0.040 mg-h⁻¹ but does not migrate and/or is not absorbed into the packaging material.

55. (canceled)

56. The insect control article of claim 23 wherein the vapour active pyrethroid is released in an amount effective to knockdown flying insects.

57. The insect control article of claim 23 wherein the flying insects are mosquitoes.

58-59. (canceled)
